(19) United States
(12) Patent Application Publication
(10) Pub. No.: US 2004/0080502 A1
(43) Pub. Date: Apr. 29, 2004

(54) Power reduction for LCD drivers by backplane charge sharing

(75) Inventors: Kevin Jones, Swindon (GB); Julian Tyrrell, Cricklade (GB)

Correspondence Address: STEPHEN B. ACKERMAN, 20 MCINTOSH DRIVE, POUGHKEEPSIE, NY, 12603, US

(73) Assignee: Dialog Semiconductor GmbH.

(21) Appl. No.: 10/288,196

(22) Filed: Nov. 5, 2002

(30) Foreign Application Priority Data
Oct. 24, 2002 (EP) 02368115.8

(51) Int. Cl. G09G 5/00

(52) U.S. Cl. 345/211

(57) ABSTRACT

This invention provides a method and an apparatus for power reduction for LCD drivers using backplane charge sharing. In addition, this invention relates to the use of switches between adjacent backplane drivers in order to transmit and reuse the discharged charge from one backplane's capacitance in order to charge the capacitance of an adjacent backplane. One embodiment of this invention utilizes N metal oxide semiconductor field effect transistors, NMOS-FETs to implement the switch connection between adjacent backplane drivers.

### Background of the Invention

1. Field of the Invention

This invention relates to a method and an apparatus for power reduction for LCD drivers using backplane charge sharing.

More particularly this invention relates to the use of switches between adjacent backplane drivers in order to transmit and reuse the discharged charge from one backplane's capacitance in order to charge the capacitance of an adjacent backplane.

2. Description of Related Art

Currently, liquid crystal display LCD panels are driven with backplane drivers. These drivers are precharged individually every cycle prior to the valid cycle of a given backplane. Similarly, these drivers are discharged individually every cycle after the given backplane is evaluated for display on the LCD panel. The power dissipated each cycle for each backplane and for each driver on the backplanes is substantial and wasteful.

U.S. Pat. No. 6,124,840 (Kwon) “Low Power Gate Driver Circuit for Thin Film Transistor-Liquid Crystal Display (TFT-LCD) Using Electric Charge Recycling Technique” describes a low power gate driver circuit for thin film transistor liquid crystal display using electric charge recycling technique.

U.S. Pat. No. 5,986,631 (Nanno, et al.) “Method for Driving Active Matrix LCD Using only Three Voltage Levels” discloses a method for driving an active matrix liquid crystal display using only three voltage levels.

U.S. Pat. No. 5,414,443 (Kanatani, et al.) “Drive Device for Driving a Matrix-type LCD Apparatus” discloses a drive device for driving a matrix-type liquid crystal display apparatus.

### BRIEF SUMMARY OF THE INVENTION

It is the objective of this invention to provide a method and an apparatus for power reduction for LCD drivers using backplane charge sharing.

It is further an object of this invention to use switches between adjacent backplane drivers in order to transmit and reuse the discharged charge from one backplane's capacitance in order to charge the capacitance of an adjacent backplane.

The objects of this invention are achieved by a method of backplane charge sharing for power reduction for LCD, liquid crystal display, liquid crystal display drivers using the steps of connecting a switch between a first backplane, backplane 1, and a second backplane, backplane 2. In addition, the method involves connecting a switch between a second backplane, backplane 2, and a third backplane, backplane 3, and connecting a switch between an nth backplane, backplane n, and an (n+1) backplane, backplane n+1. This method also involves attaching a backplane control signal to each of said backplane switches which connect adjacent backplanes. The method also uses switching between backplane 1 and backplane 2, switching between backplane 2 and backplane 3, and switching between a backplane n and a backplane n+1 where n =3, 4, 5, . . . The switch is opened by a backplane 1 control signal, for a short period of time at the beginning of each backplane period.

The method also involves the opening of the switch between adjacent backplanes. This open switch allows the discharge of one half of backplane 1's charge from backplane 1's capacitance into the capacitance of backplane 2.

This method results in the sharing of charge between backplane 1 and backplane 2.

A circuit for implementing the switch for the backplane charge sharing for power reduction for LCD, liquid crystal display, drivers is made up of two field effect transistors, FETs, whose drains and sources are connected in common and whose gates are connected to said backplane control signals. The common drains of the FETs are connected to backplane 1 capacitance. The sources of the FETs are connected to backplane 2 capacitances. The gates of the FETs are connected to a switch control signal which when active allows the transfer of charge from the common drains connected to backplane 1 to the common sources connected to backplane 2.

### BRIEF DESCRIPTION OF THE DRAWINGS

FIG. 1 shows a timing diagram of the backplane drivers for an LCD panel system of this invention.

FIG. 2a gives a block diagram showing the backplane drivers and switches used to implement the main embodiment of this invention.

FIG. 2b shows two NMOS —FETs used in the apparatus of this invention in order to create switches between adjacent backplane driver capacitances.

FIG. 3 illustrates the simultaneous discharging and charging of adjacent backplane drivers on a timing diagram.

### DETAILED DESCRIPTION OF THE INVENTION

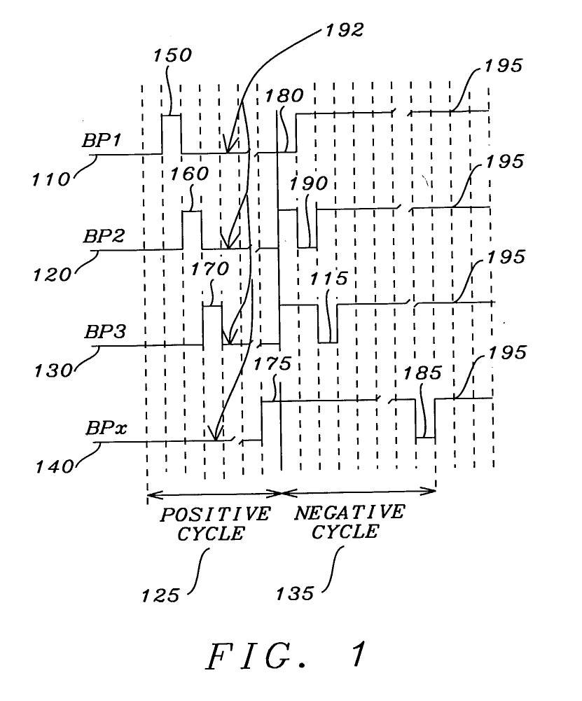

FIG. 1 shows the backplane driver voltage levels which result form the main embodiment of this invention. Backplane driver 1, BP1 110 has its voltage level 150 shown in FIG. 1. Backplane driver 2, BP2 120 has its voltage level 160 shown in FIG. 1. Backplane driver 3, BP3 130 has its voltage level 170 shown in FIG. 1. The generalized backplane driver n 140 has its voltage level 175 shown in FIG. 1. The timing diagram of FIG. 1 is divided into a positive cycle 125 and a negative cycle 135. The positive cycle 125 occurs when the backplane driver capacitances are being driven high and charged. This FIG. 1 clearly shows that each common backplane driver is fully charged to the same voltage as the preceding common backplane driver. Also, at the end of each backplane period of the positive cycle, the backplane driver is fully discharged 192.

The negative cycle 135 occurs when the backplane driver capacitances are being driven low and discharged. FIG. 1 shows the discharged level of BP1's driver 180. It also shows the discharged level of BP2's driver 190. In addition, FIG. 1 illustrates the discharged level of BP's driver 115. Finally, the general case of the BPn driver's 140 discharge level is shown in FIG. 1-185.

This FIG. 1 also clearly shows that each common backplane driver is fully discharged to the same voltage as the preceding common backplane driver. Also, at the end of each backplane period of the negative cycle 135, the backplane driver is fully charged 195.

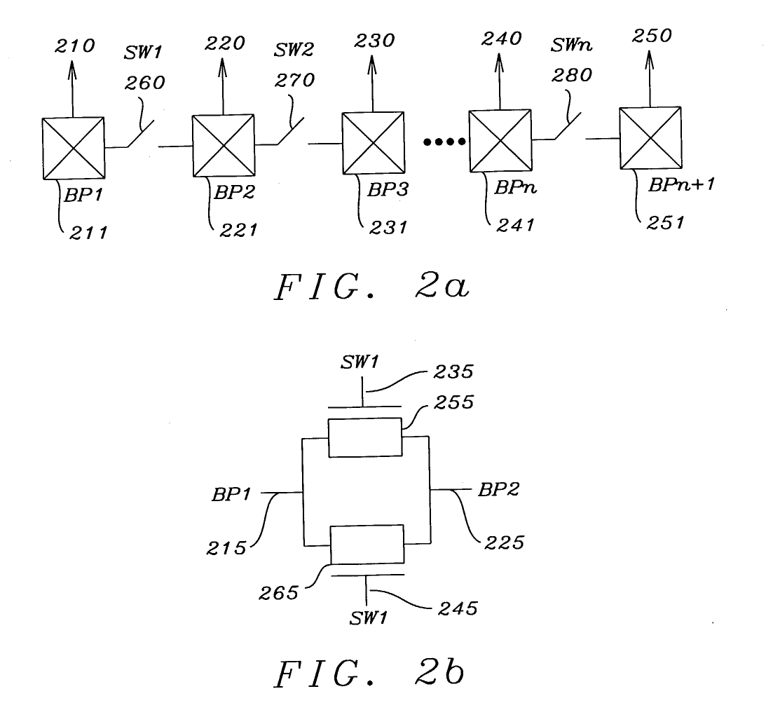

FIG. 2a shows the backplane drivers 210, 220, 230, 240, 250. The output pads of the backplane drivers are illustrated by 211, 221, 231, 241, 251. These output pads are connections to off-chip connections which include the largely capacitive LCD display panel. The switch between backplane 1-210 and backplane 2-220 is shown as SW1-260. The switch between backplane 2-220 and backplane 3-230 is labeled SW2-270. The switch between backplane n-240 and backplane n+1 250 is shown as SWn 280.

FIG. 2b shows a field effect transistor, FET implementation of switch SW1 of FIG. 2a. As shown in FIG. 2b, the drains of NMOS (N-metal oxide semiconductor) FETs 255 and 265 are connected in common. These common drains are tied to Backplane 1, BP1-215. The sources of FETs 255 and 265 are connected in common. These common sources are connected to Backplane 2, BP2-225. The gate 235 of FET 255 and the gate 245 of FET 265 are tied to the SW1 switch control signal.

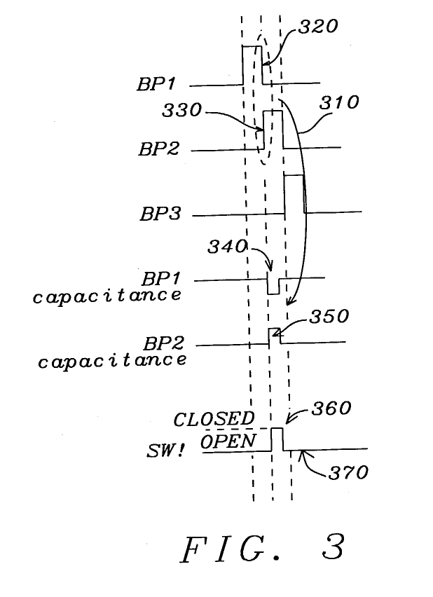

FIG. 3 shows the transition between Backplane 1″s active time and Backplane 2's active time. The falling edge of Backplane 1's driver 320 corresponds to the rising edge of Backplane 2's driver 330. The backplane 1 capacitance 340 is discharged during this transition 310. The backplane 2's capacitance 350 is charged during this transition. Half of the charge from BP1's capacitance 340 is used to charge BP2's capacitance 350. This is the charge-sharing embodiment of this invention. This charge sharing results in power savings. The switch 1 control signal SW1 is shown being opened closed 360 and then opened 370 in FIG. 3.

The advantage of this power reduction for LCD drivers by backplane charge sharing method is the saving of one-half of the charging power. This is done by introducing a switch between the backplane drivers. The switch allows the discharging the backplane capacitance for a short period of time. During this short period of time the adjacent backplane is allowed to charge itself using the charge which is simultaneously discharged from the initial backplance capacitance.

While this invention has been particularly shown and described with Reference to the preferred embodiments thereof, it will be understood by those Skilled in the art that various changes in form and details may be made without Departing from the spirit and scope of this invention.

What is claimed is:

1. A method of backplane charge sharing for power reduction for LCD, liquid crystal display, liquid crystal display drivers comprising the steps of:
connecting a switch between a first backplane, backplane 1, and a second backplane, backplane 2,
connecting a switch between a second backplane, backplane 2, and a third backplane, backplane 3, and
connecting a switch between an nth backplane, backplane n, and an (n+1) backplane, backplane n+1.

2. The charge sharing method of claim 1 further comprising the steps of:
attaching a backplane control signal to each of said backplane switches which connect adjacent backplanes.

3. The charge sharing method of claim 1 further comprising the steps of:
switching between backplane 1 and backplane 2,
switching between backplane 2 and backplane 3, and
switching between a backplane n and a backkplane n+1 where n =3, 4, 5,...

4. The method of claim 1 wherein said backplane 1 switch is opened by a backplane control signal 1, for a short period of time at the beginning of each backplane period.

5. The method of claim 4 wherein said open switch 1 discharges one half of backplane 1's charge from backplane 1's capacitance into the capacitance of backplane 2.

6. The method of claim 5 wherein said discharge of backplane 1 and the charge of backplane 2 results in the sharing of charge between backplane 1 and backplane 2.

7. The method of claim 1 wherein said backplane 2 switch is opened by a backplane control signal 2, for a short period of time at the beginning of each backplane period.

8. The method of claim 7 wherein said backplane 2 switch which is open discharges one half of backplane 2's charge from backplane 2's capacitance into the capacitance of backplane 3.

9. The method of claim 8 wherein said discharge of backplane 2 and the charge of backplane 3 results in the sharing of charge between backplane 2 and backplane 3.

10. The method of claim 1 wherein said backplane n switch is opened by a backplane n+1 control signal, for a short period of time at the beginning of each backplane period.

11. The method of claim 10 wherein said open switch n discharges one half of backplane n+1's charge from backplane n's capacitance into the capacitance of backplane n+1.

12. The method of claim 11 wherein said discharge of backplane n and the charge of backplane n+1 results in the sharing of charge between backplane n and backplane n+1.

13. An apparatus for backplane charge sharing for power reduction for LCD, liquid crystal display, liquid crystal display drivers comprising:
a first switch between a first backplane, backplane 1, and a second backplane, backplane 2,
a second switch between a second backplane, backplane 2, and a third backplane, backplane 3, and
an n switch between an nth backplane, backplane n, and an (n+1) backplane, backplane n+1.

14. The charge sharing apparatus of claim 13 further comprising:
a backplane control signal attached to each of said backplane switches which connect adjacent backplanes.

15. The charge sharing apparatus of claim 13 further comprising:
means for switching action between backplane 1 and backplane 2,
means for switching action between backplane 2 and backplane 3, and
means forswitching action between a backplane n and a backkplane n+1 where n =3, 4, 5,. . .

16. The charge sharing apparatus of claim 13 wherein said backplane 1 switch is opened by said backplane 1 control signal, for a short period of time at the beginning of each backplane period.

17. The charge sharing apparatus of claim 16 wherein said open switch 1 discharges one half of backplane 1's charge from backplane 1's capacitance into the capacitance of backplane 2.

18. The charge sharing apparatus of claim 17 wherein said discharge of backplane 1 and the charge of backplane 2 results in the sharing of charge between backplane 1 and backplane 2.

19. The charge sharing apparatus of claim 13 wherein said backplane 2 switch is opened by said backplane 2 control signal, for a short period of time at the beginning of each backplane period.

20. The charge sharing apparatus of claim 19 wherein said open switch 2 discharges one half of backplane 2's charge from backplane 2's capacitance into the capacitance of backplane 3.

21. The charge sharing apparatus of claim 20 wherein said discharge of backplane 2 and the charge of backplane 3 results in the sharing of charge between backplane 2 and backplane 3.

22. The charge sharing apparatus of 13 wherein said backplane n switch is opened by a backplane n+1 control signal, for a short period of time at the beginning of each backplane period.

23. The charge sharing apparatus of claim 22 wherein said open switch n discharges one half of backplane n+1's charge from backplane n's capacitance into the capacitance of backplane n+1.

24. The charge sharing apparatus of claim 23 wherein said discharge of backplane n and the charge of backplane n+1 results in the sharing of charge between backplane n and backplane n+1.

25. A circuit for implementing said switch for the backplane charge sharing for power reduction for LCD, liquid crystal display, drivers comprising:
two field effect transistors, FETs, whose drains and sources are connected in common and whose gates are connected to backplane control signals.

26. The circuit of claim 25 wherein said common drains are connected to said backplane 1 capacitance and said sources are connected to said backplane 2 capacitances.

27. The circuit of claim 25 wherein said gate control signal allows the transfer of charge from the common drains connected to backplane 1 to the common sources connected to backplane 2.

28. The circuit of claim 25 wherein said common drains are connected to said backplane 2 capacitance and said sources are connected to said backplane 3 capacitances.

29. The circuit of claim 25 wherein said gate control signal allows the transfer of charge from the common drains connected to backplane 2 to the common sources connected to backplane 3.

30. The circuit of claim 25 wherein said common drains are connected to said backplane n capacitance and said sources are connected to said backplane n+1 capacitance.

31. The circuit of claim 25 wherein said gate control signal allows the transfer of charge from the common drains connected to backplane n to the common sources connected to backplane n+1.
